(19) United States
(12) Patent Application Publication
(10) Pub. No.: US 2026/0131392 A1
(43) Pub. Date: May 14, 2026

(54) METHOD FOR GRINDING A TOOTHING OR A PROFILE OF A WORKPIECE

(71) Applicant: KAPP NILES GMBH & CO. KG, Coburg (DE)

(72) Inventors: Achim STEGNER, Coburg (DE); Philip GEILERT, Ahorn (DE)

(21) Appl. No.: 19/119,357

(22) PCT Filed: Oct. 6, 2023
(86) PCT No.: PCT/EP2023/077793

§ 371 Date: Apr. 8, 2025

(30) Foreign Application Priority Data
Oct. 22, 2022 (DE) 10 2022 127 965.0

(51) Int. Cl. B23F 1/02

(52) U.S. Cl. CPC B23F 1/02

(57) ABSTRACT

A method for grinding a toothing of a workpiece by a grinding tool. The grinding tool is mounted on a tool spindle and the tool spindle is turned by a first drive motor. The workpiece is mounted on a workpiece spindle that is turned by a second drive motor. A rotational acceleration sensor is arranged in the region of the tool drivetrain and/or in the region of the workpiece drivetrain. The values recorded by the rotational acceleration sensor for the rotational acceleration of the tool spindle and/or of the workpiece spindle are transmitted to a data processing system and are evaluated. The measured signal of the rotational acceleration is subjected to a frequency analysis, wherein the amplitudes of the individual frequency components are determined, respective limit values are specified for the amplitudes, a signal is output by the data processing system if one of the limit values is exceeded, and the frequency components are only monitored with regard to their amplitude.

The invention relates to a method for grinding a toothing or a profile of a workpiece by means of a grinding tool in a grinding machine, wherein the grinding tool is received on a tool spindle and the tool spindle is rotated by means of a first drive motor, so that a tool drivetrain is present, and wherein the workpiece is received on a workpiece spindle and the workpiece spindle is rotated by means of a second drive motor, so that a workpiece drivetrain is present, wherein at least one angular acceleration sensor is arranged in the area of the tool drivetrain and/or in the area of the workpiece drivetrain, wherein the values for the angular acceleration of the tool spindle and/or the workpiece spindle recorded by the angular acceleration sensor are transmitted to a data processing system, especially to a machine control, and evaluated by the latter.

A method of the generic type is disclosed in WO 2015/036519 A1. The document mentions that an angular acceleration sensor can be arranged in a machine tool, wherein a signal transmission takes place by means of a first and a second antenna coil to enable wireless signal transmission between the antenna coils.

Another method is known from WO 2022/100972 A2. Here, during the machining of a toothing, a grinding worm is used to monitor several machine parameters, which can be the power or current consumption of the motors or structure-borne sound signals. These are then evaluated in the machine control system to determine whether they are within permissible limits. If this is not the case, a corresponding warning is issued indicating that the grinding process cannot be carried out properly.

WO 2022/207371 A1 discloses that signals are recorded during the hard-fine machining of a workpiece, wherein, in the event that the measured signals lie outside a predetermined tolerance, the workpiece is measured in a measuring device after machining.

It has been found that it is desirable to achieve an even higher level of accuracy when monitoring the known variables.

The invention is therefore based on the object of further developing a method of the type mentioned at the beginning and providing a grinding machine with the appropriate equipment in such a way that improved monitoring of the grinding process is possible.

The solution of this object is characterized according to the method in that the measured signal of the angular acceleration is subjected to a frequency analysis, wherein the individual frequency components are determined with regard to their amplitude, wherein respective limit values are predetermined for the amplitudes of the frequency components, wherein a signal is output by the data processing system when at least one of the limit values is exceeded, and wherein the frequency components are monitored only with regard to their amplitude.

The data processing system can also be an industrial PC connected to the machine.

The preferred location for the angular acceleration sensor is between the first drive motor and the tool and/or between the second drive motor and the workpiece. However, the sensor can also be provided beyond the areas mentioned in each case; it must only be able to detect the respective rotational acceleration of the spindle. To do this, the acceleration sensor can also be placed in the area of a spindle counterbearing, for example.

The acquisition and evaluation of measurement data from the angular acceleration sensor is preferably carried out while the tool is in contact with the toothing or profile of the workpiece. The acquisition and evaluation of measurement data from the angular acceleration sensor is preferably (only) carried out while the tool is in contact with the toothing or profile of the workpiece.

Alternatively, it is also possible to record and evaluate measurement data from the acceleration sensor during operation of the first and/or second drive motor without the tool engaging with the toothing or profile of the workpiece. Accordingly, the evaluation of the signals from the angular acceleration sensor is carried out in “idle”, so to speak, which makes it possible to draw conclusions about the condition of machine components and the causes of impending malfunctions. These conclusions can be drawn particularly easily if the evaluation of the signals from the angular acceleration sensor is repeated periodically. The first evaluation can be carried out, for example, after the machine has been started up, and further evaluations can be carried out periodically; changes in the signals then allow conclusions to be drawn about changes in the machine.

A special analysis in the aforementioned “idle” operation is designed so that the data collection occurs during the run-up of the motors (in particular at constant rotational acceleration) and the dynamic behavior of the system is recorded via the angular acceleration sensor. Conclusions about the machine condition can also be drawn from this. In particular, it is possible to specify that the data acquisition of the angular acceleration values from the angular acceleration sensor should take place during the run-up from a standstill to a specified final rotational speed of the spindle.

Another alternative involves the measurement and evaluation of data from the angular acceleration sensor, which in this case is located in the area of the tool drivetrain, during dressing of the tool by means of a dressing tool. This allows conclusions to be drawn about the dressing system. In this regard, a special embodiment of the invention provides that an angular acceleration sensor is also arranged in the area of the drivetrain for driving the dressing tool and the data detected by this sensor is evaluated. This can be very helpful for analyzing the dressing process, in particular if the data analysis described below is carried out.

The data processing system can output a signal if the measured acceleration exceeds a specified tolerance.

The evaluation of the measured values for the acceleration can be carried out in the time domain—not according to the invention.

According to a preferred approach, the aforementioned frequency analysis is to be carried out using a Fast Fourier Transformation (FFT).

However, alternative and well-known methods can also be used for this purpose, in particular a discrete Fourier transform (DFT), a root-mean-square analysis (determination of the RMS spectrum), a determination of the amplitude spectrum, a cepstrum analysis, an equalization sinus function or a determination of the auto-power spectrum (PSD analysis). The signal analysis methods mentioned are well known and therefore do not need to be discussed in detail here.

The acquisition of the values of the angular acceleration sensor is preferably carried out during a predetermined time interval while the workpiece is being ground with the grinding tool. It can also be provided that the acquisition of the values of the angular acceleration sensor takes place between two defined positions, in particular over a predetermined feed distance while the workpiece is being ground with the grinding tool. The recording of the angular acceleration can therefore be both temporally and spatially defined (i.e. for example over the course of the grinding stroke between predefined positions, but also over an area of a feed or a shift movement of a spindle). This makes it possible to observe particularly relevant sections of the grinding process and to make comparisons with previously stored data.

Grinding is preferably a generating grinding of a gear wheel with a grinding worm.

A grinding machine for grinding a toothing or a profile of a workpiece by means of a grinding tool, having a tool spindle for receiving the grinding tool and a first drive motor for driving the tool spindle, so that a tool drivetrain is present, and a workpiece spindle for receiving the workpiece and a second drive motor for driving the workpiece spindle, so that a workpiece drivetrain is present, can be designed such that an angular acceleration sensor is arranged in the region of the tool drivetrain and/or in the region of the workpiece drivetrain, which sensor is connected to a data processing system, in particular to a machine control.

The proposed concept therefore provides for monitoring and evaluation of the grinding process, in particular the generating gear grinding process, by evaluating the angular acceleration measured during the grinding process at the workpiece spindle and, if necessary, also or alternatively at the tool spindle by means of an angular acceleration sensor.

It has been found that the angular acceleration, in particular after the signal-technical evaluation as described above (i.e. after a frequency analysis), provides very useful information on how the grinding process is shaping up and whether it is running properly.

This means that the grinding process can be effectively monitored and defective or conspicuous components can be detected in good time. In particular, defects on the raw part of the workpiece, waviness on the flanks of the ground gear wheel and also tool defects can be detected.

The evaluation is preferably carried out by referring to stored data (in the machine control) and thus to knowledge gained from previous grinding processes. Process deviations (anomalies) can be detected more effectively, so that the machine operator can be warned or the grinding process can be aborted.

In addition to the described measurement of the angular acceleration, further control-internal signals (i.e. those that are present in the machine control) and also control-external signals (e.g. measured via sensors that pick up structure-borne sound, which may originate from the machine bed or the hall floor, for example) can be recorded and taken into account.

In addition, machine-internal data (such as the set corrections, the diameter of the grinding worm, generated paths along which the workpiece and the tool are guided relative to each other) can be used to evaluate the process, for which they may be adaptively filtered and sorted (e.g. by dividing the entire grinding process into different strokes, subdividing into inlet, outlet and complete engagement of the workpiece and tool).

Depending on the factors influencing the process, in particular with regard to the generated course (influenced by screw diameter and corrections), characteristic values can be calculated and output.

With the help of algorithms from statistics and in particular from the field of machine learning, these data are preferably evaluated and the quality of the machining process is determined. The algorithms known per se from the field of machine learning include both supervised and unsupervised learning, “deep learning” and “reinforcement learning”.

This makes it possible to increase the monitoring quality and thus stabilise the grinding process. It is possible to recognise more effectively whether the process is faulty, and the type of fault can also be identified more accurately. The prerequisite for this is that the data stored (in the machine control system) includes information on this or a similar fault.

In addition to recognising the error, this also enables faster troubleshooting. Building on this knowledge, the machine is able to intervene adaptively in the process and optimise it.

As mentioned, the measurement signals in the process can be subdivided into areas that are meaningful for the evaluation of the process on the basis of knowledge about the grinding process. Thus, it is not absolutely necessary to evaluate the entire machining process, but only relevant areas.

The drawing shows an embodiment of the invention.

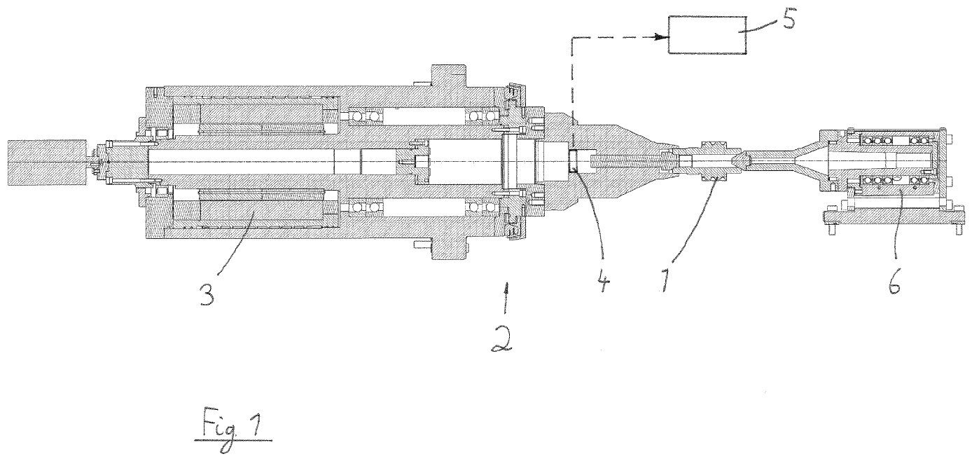

FIG. 1 shows a workpiece spindle of a grinding machine with a workpiece to be ground,

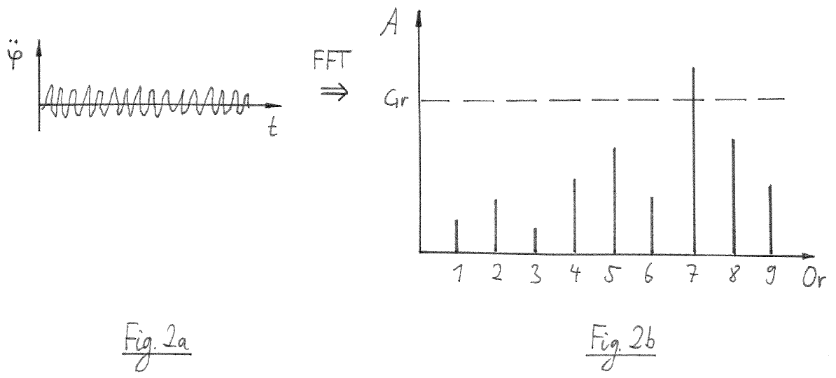

FIG. 2a schematically shows the recording of the course of the angular acceleration of the workpiece spindle over time, and

FIG. 2b schematically shows the amplitudes of the frequency components obtained from a Fast Fourier Transformation (FFT) of the signal according to FIG. 2a.

FIG. 1 shows a workpiece spindle 2 on which a workpiece 1 to be ground in the form of a gear wheel is clamped. The workpiece spindle 2 is driven by a drive motor 3. This constitutes a workpiece drivetrain. It is essential that an angular acceleration sensor 4 is integrated into the drivetrain, in the embodiment between the drive motor 3 and the workpiece 1, which is able to detect the angular acceleration of the workpiece spindle 2 around its longitudinal axis. The values obtained in this way are transmitted to a data processing system 5, which may, for example, be the machine control system. Alternatively, an industrial PC can also be used as a data processing system.

A tailstock 6 is also shown, which supports the workpiece 1. As an alternative to the solution shown, it would also be conceivable to arrange the angular acceleration sensor 4 in the area of the tailstock 6. The only important thing is that the angular acceleration of the workpiece spindle 2 can be recorded.

The measurements recorded by the angular acceleration sensor 4 are schematically sketched in FIG. 2a over time, i.e. the second derivatives of the rotation angle.

The so recorded signal is subjected to a Fast Fourier Transformation (FFT) to determine the individual frequency components and in particular their amplitude A. This is shown in FIG. 2b.

The recorded curve in FIG. 2b has therefore been subjected to an FFT (Fast Fourier Transformation) to break down the periodic signal in FIG. 2a into its components (the “harmonics”). FIG. 2b shows the amplitude A of the individual frequency components of the recorded periodic signal in relation to the order Or.

A limit value Gr is specified for the individual amplitudes A, which must not be exceeded in order to justify the assumption that the grinding process was carried out properly. As can be seen from FIG. 2 b, this is not the case for the 7th order of the analyzed curve according to FIG. 2a, since the limit Gr has been exceeded here. It can therefore be seen in FIG. 2b that a frequency component is above the limit Gr, so it can be concluded that no proper grinding process has taken place.

Of course, different values for the permissible amplitude A can also be specified for the individual orders Or (in contrast to the representation according to FIG. 2b).

The grinding process is the last shaping process in the production of gears. Rotational errors of the workpiece and tool axes have a particularly adverse effect on the noise behavior of the toothing in the gearbox, especially during generating grinding. These can be effectively measured with the angular acceleration devices proposed in the invention and evaluated using an order analysis. By teaching in limits, workpieces that have not been properly machined can be detected and sorted out during the grinding process.

Particularly with higher-frequency signals (over 150 Hz), measuring the displacement of the angle (using an angle measurement system) can be disadvantageous, while a measurement of the acceleration has potential here. The amplitude of the vibration displacement of a torsional vibration decreases reciprocally with increasing frequency at a constant vibration velocity. The velocity amplitude increases linearly with frequency, while the acceleration increases quadratically with frequency.

The components of the angular acceleration device to be integrated into the (workpiece) spindle essentially include the (rotating) acceleration sensor and a signal transmission unit. The two components can be constructed together or separately.

The preferred option is to integrate the angular acceleration sensor into the workpiece spindle. The drivetrain consists, for example, of a rotary feedthrough, a workpiece spindle shaft, an intermediate flange, the clamping device, the workpiece, the tailstock centre and the tailstock sleeve.

Preferably, the angular acceleration sensor and the signal transmission unit are arranged in or near the workpiece spindle shaft, the intermediate flange, the clamping device or the tailstock sleeve.

However, it is also possible to locate the angular acceleration sensor in the drivetrain of the tool spindle. This consists, for example, of the tool spindle shaft, the tool arbor and the counter bearing shaft. In this case, the acceleration sensor and the signal transmission unit are preferably located in or near the tool spindle shaft, the tool arbor or the counter bearing shaft.

An angular acceleration sensor suitable for use on the rotating system in accordance with the invention is, for example, manufactured and offered by Discom-Elektronische Systeme und Komponenten GmbH. The angular acceleration sensor detects any deviation from uniform rotation.

The angular acceleration sensor preferably consists of a stator that is stationary and a rotor that is mounted on the rotating shaft to be measured. The stator supplies the rotor with power and receives the data from the rotating part of the angular acceleration sensor (preferably from two acceleration sensors installed at 180°). The signal transfer from the rotor to the stator can be done optically.

When the above refers to an angular acceleration sensor integrated into the workpiece or tool spindle, it should be understood that more than one such sensor can be provided.

The embodiment shows the use of an FFT. Alternatively, any other known method of frequency analysis can be used, in particular the discrete Fourier transform (DFT), frequency analysis by means of a root-mean-square analysis (determination of the RMS spectrum), by determining the amplitude spectrum, by a cepstrum analysis (including variants such as power cepstrum), by an equalization sinus function or by a determination of the auto power spectrum (PSD analysis). In measurement data analysis, the methods described are all known as such, so they need not be discussed in detail here. The only important thing is that the individual frequency components for the measured periodic signal components are determined by a frequency analysis and the results obtained from this are used for comparison with permissible limit values (in particular for the maximum permissible values of the individual amplitudes of the “harmonics”).

The proposed method can, in principle, be used with any grinding cycle, especially with variable-speed grinding.

### List of References

1 Workpiece (gear wheel)
2 Workpiece spindle
3 Drive motor
4 Angular acceleration sensor
5 Data processing system (machine control)
6 Tailstock

1-10. (canceled)

11. A method for grinding a toothing or a profile of a workpiece by a grinding tool in a grinding machine, in particular generating grinding of a gear wheel with a grinding worm,
wherein the grinding tool is received on a tool spindle and the tool spindle is rotated by a first drive motor, so that a tool drivetrain is present, and
wherein the workpiece is received on a workpiece spindle and the workpiece spindle is rotated by a second drive motor, so that a workpiece drivetrain is present,
wherein at least one angular acceleration sensor is arranged in the area of the tool drivetrain and/or in the area of the workpiece drivetrain, wherein the values for the angular acceleration of the tool spindle and/or the workpiece spindle recorded by the angular acceleration sensor are transmitted to a data processing system and evaluated by the latter,
wherein the measured signal of the angular acceleration is subjected to a frequency analysis,
wherein the individual frequency components are determined with regard to their amplitude,
wherein respective limit values are predetermined for the amplitudes of the frequency components, wherein a signal is output by the data processing system when at least one of the limit values is exceeded, and wherein the frequency components are monitored only with regard to their amplitude.

12. The method according to claim 11, wherein the angular acceleration sensor is arranged between the first drive motor and the tool and/or between the second drive motor and the workpiece.

13. The method according to claim 11, wherein the recording and evaluation of measurement data from the angular acceleration sensor is carried out during the engagement of the tool in the toothing or the profile of the workpiece.

14. The method according to claim 11, wherein the recording and evaluation of measurement data from the angular acceleration sensor takes place during the operation of the first and/or second drive motor, without the tool engaging with the toothing or the profile of the workpiece.

15. The method according to claim 11, wherein the recording and evaluation of measurement data from the angular acceleration sensor is carried out during dressing of the tool by a dressing tool.

16. The method according to claim 11, wherein the frequency analysis is carried out by a Fast Fourier Transformation (FFT).

17. The method according to claim 11, wherein the frequency analysis is carried out by a discrete Fourier transform (DFT).

18. The method according to claim 11, wherein the frequency analysis is carried out by a root-mean-square analysis (determination of the RMS spectrum) or by a determination of the amplitude spectrum or by a cepstrum analysis or by an equalization sinus function or by a determination of the auto power spectrum (PSD analysis).

19. The method according to claim 11, wherein the values of the angular acceleration sensor are recorded during a predetermined time interval while the workpiece is being ground with the grinding tool.

20. The method according to claim 11, wherein the values of the angular acceleration sensor are detected between two defined positions.
